(19) United States
(12) Patent Application Publication
(10) Pub. No.: US 2011/0095465 A1
(43) Pub. Date: Apr. 28, 2011

(54) Cutting board

(76) Inventor: Stephanie VLAHOS, Palm Desert, CA (US)

(21) Appl. No.: 12/925,410

(22) Filed: Oct. 21, 2010

Related U.S. Application Data
(60) Provisional application No. 61/253,529, filed on Oct. 21, 2009.

(51) Int. Cl. A47J 47/00

(52) U.S. Cl. 269/16

(57) ABSTRACT

A cutting board, which includes a pair of substantially planar members, which are separated by at least two support members and forms a slot or space configured to receive a tray. The tray fits between the pair of substantially planar members, the tray having at least one compartment configured to receive food from at least one of the pair of substantially planar members. The tray includes a plurality of compartments.

### TECHNICAL FIELD

This invention relates to a cutting board of the type commonly found in the home used for cutting various food items including, but not limited to poultry, meats, vegetables, fruits and the like, and more particularly to a cutting board having an inner tray having at least one compartment for holding poultry, meats, vegetables, fruits and the like upon slicing, dicing and/or chopping thereof.

### BACKGROUND OF THE INVENTION

The use of what is commonly referred to as a “cutting board” is common in kitchens today, both in commercial kitchens and household kitchens. Typically, a cutting board is nothing more than a slab of material upon which a cook can cut and otherwise prepare foodstuffs. Originally, cutting “boards” were manufactured of a slab of wood. While wood cutting boards are still common, cutting boards of other materials, including but not limited to plastics, glass, ceramics, composites, and silicones are also common. Common sizes of cutting board include, but are not limited to, eleven inches by fourteen inches and twelve inches by sixteen inches. As for thickness, cutting boards can be thick (one inch or more) or thin (thin cutting mats a fraction of an inch thick are common today).

Cutting boards are used for a number of different reasons. For instance, the use of a cutting board protects the countertop surface from damage caused by cutting instruments, such as knives. If a cutting board is not used, the knife can score and nick countertop surface, thereby damaging its finish.

Another reason cutting boards are used is to provide a cutting support surface softer than the knife itself, thereby allowing the knife to cut through the foodstuff without overly dulling or otherwise damaging the knife. For instance, if a cook were to chop vegetables on a granite countertop, the granite would not only become damaged, but would (due to its hardness) itself dull and damage the knife's cutting surface. Cutting boards are also used to maintain kitchen sanitation. For instance, rather than cutting certain foodstuffs (e.g., raw poultry) on a countertop that is also used in aspects of the cooking process, a cutting board is used. By limiting the kitchen's potential contamination to the cutting board (rather than the entire countertop surface), the chances of cross-contamination are decreased and cleanup (of potential contamination) is made simpler (e.g., the “contaminated” cutting board can be moved off of the preparation surface and sanitized in the normal manner (placed into a dishwasher)) without the entire preparation surface needing to be sanitized.

It would be desirable to have a cutting board, which includes a tray or insert, which fits within the cutting board and has at least one compartment, and wherein the food slides into the at least one compartment as the food preparer slices, dices or chops the food into smaller portions.

### SUMMARY OF THE INVENTION

In accordance with an exemplary embodiment, a cutting board comprises: a pair of substantially planar members, which are separated by at least two support members and forms a slot or space configured to receive a tray.

In accordance with another exemplary embodiment, the cutting board further includes a tray, which fits between the pair of substantially planar members, the tray having at least one compartment configured to receive food from at least one of the pair of substantially planar members.

In accordance with a further exemplary embodiment, the tray includes a plurality of compartments.

### BRIEF DESCRIPTION OF THE DRAWINGS

FIG. 1 is a perspective view of a cutting board having an inner tray with a plurality of compartments in accordance with an exemplary embodiment.

FIG. 2 is another perspective view of a cutting board having an inner tray with a plurality of compartments in accordance with an exemplary embodiment.

FIG. 3 is a perspective view of a cutting board in accordance with another exemplary embodiment.

FIG. 4 is another perspective view (i.e., end view) of a cutting board having a pair of inner trays.

FIG. 5 is a perspective view of a cutting board in accordance with an exemplary embodiment, wherein the cutting board is configured to receive a pair of trays.

FIG. 6 is a perspective view of a pair of cutting boards in accordance with another exemplary embodiment.

FIG. 7 is another perspective view of a pair of cutting boards in accordance with an exemplary embodiment.

### DETAILED DESCRIPTION OF THE DRAWINGS

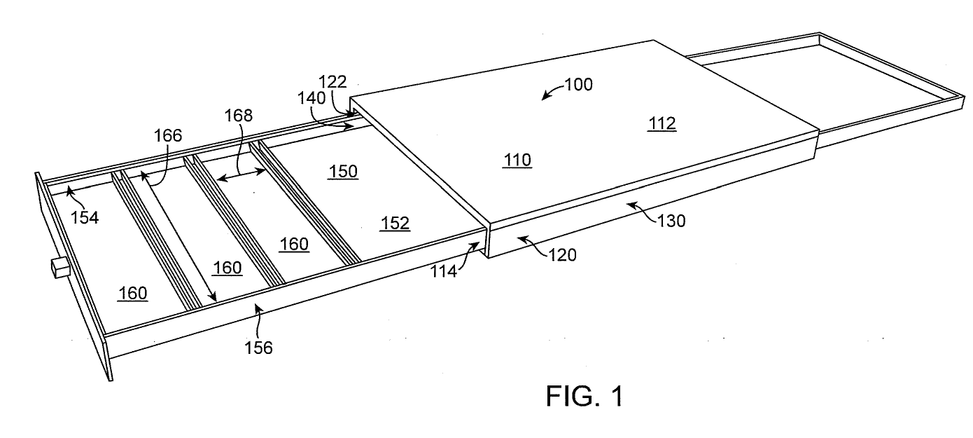

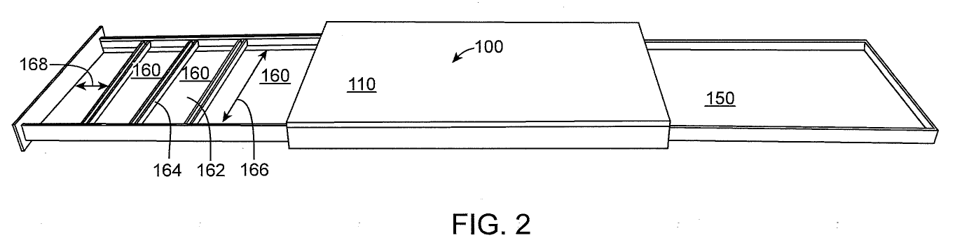

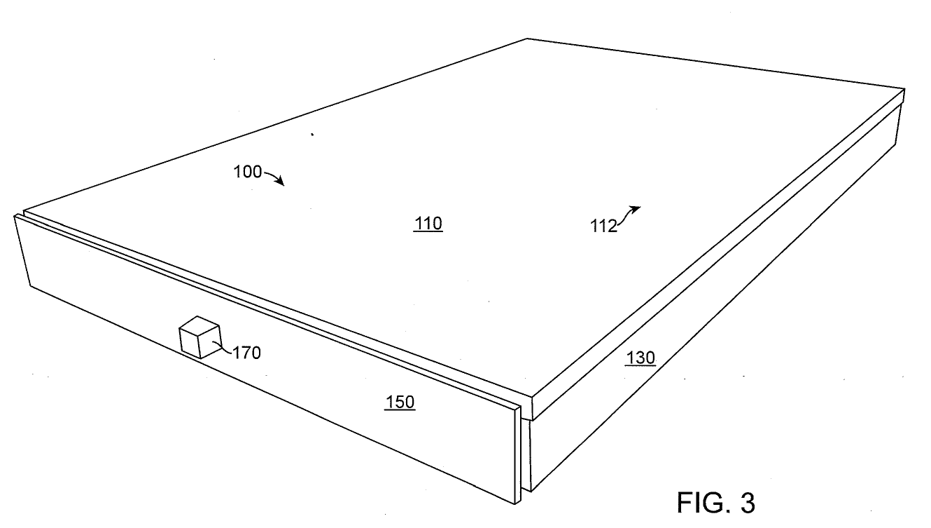

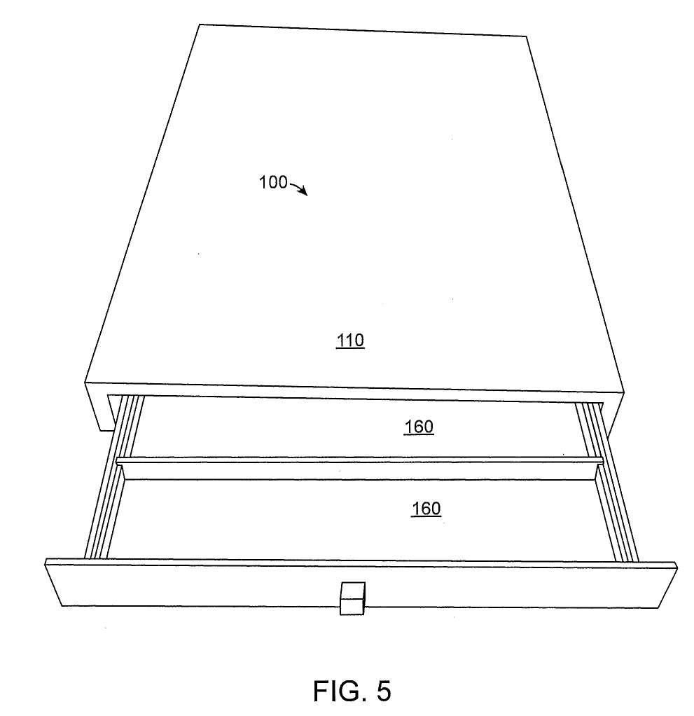

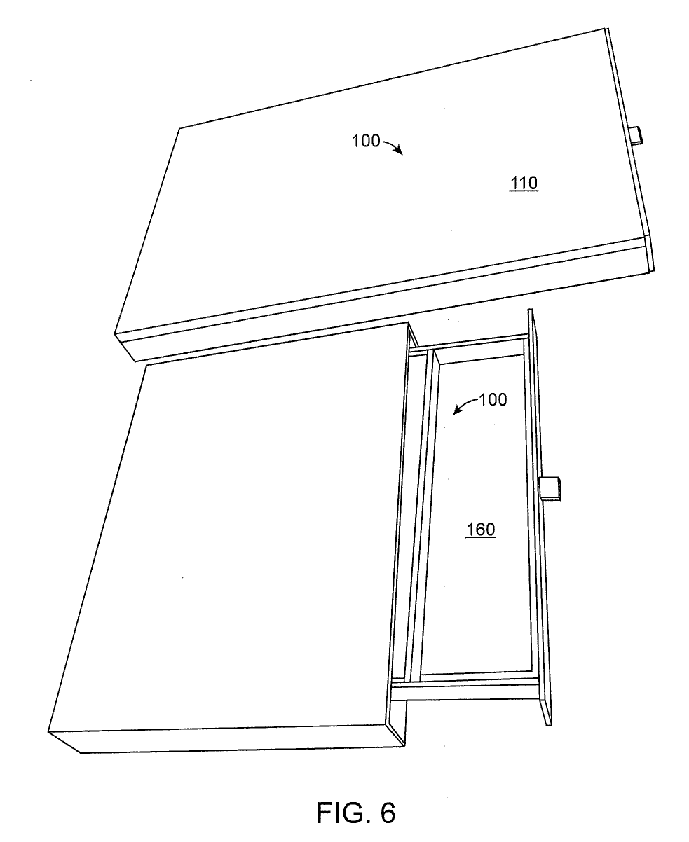

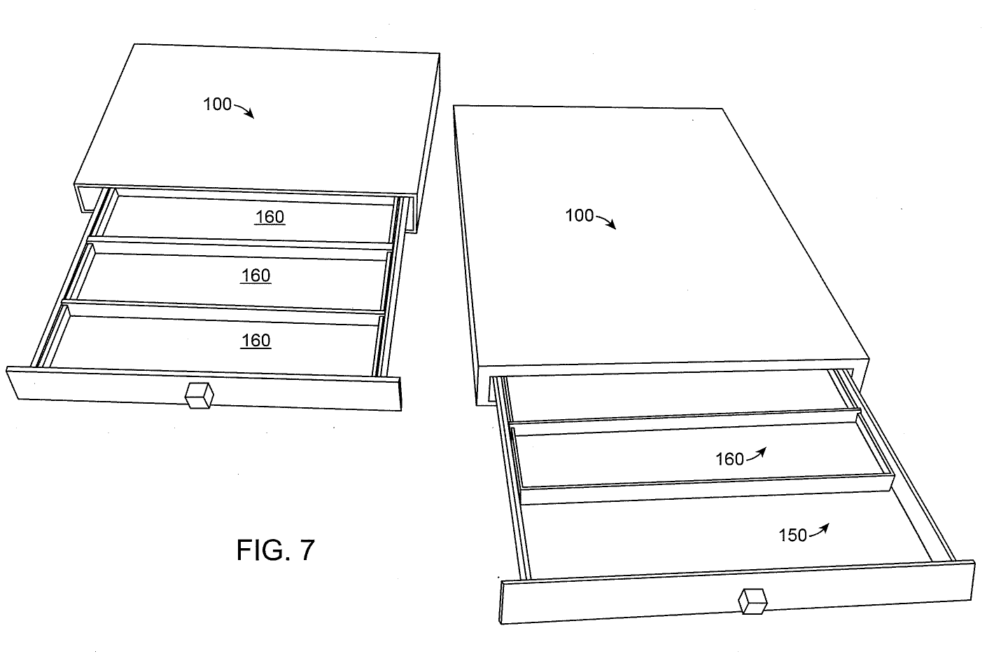

FIGS. 1-7 are perspective views of a cutting board 100 (or a pair of cutting boards as shown in FIGS. 6 and 7) having an inner tray with at least one compartment in accordance with an exemplary embodiment. The cutting board 100 includes a pair of substantially planar members 110, 120, which are separated by at least two support members 130, 132 and forms a slot or space 140 configured to receive a tray 150. It can be appreciated that one or both of the substantially planar members 110, 120 includes a cutting surface 112, 122. As shown in FIGS. 1-7, the tray 150 fits between an inner surface 114, 124, on each of the substantially planar members 110, 120. In accordance with an exemplary embodiment, the tray 150 is a substantially planar member 152 having a pair of vertical edges 154, 156.

As shown in FIGS. 1-7, the cutting board 100 is preferably rectangular in shape. It can be appreciated that in accordance with an exemplary embodiment, the cutting board 100 has a length of approximately 8 to 36 inches in length, a width of 6 to 24 inches, and a depth of 1 to 5 inches. It can be appreciated that the tray 150 and at least one compartment 160 are also preferably rectangular in shape. The at least compartment 160 is preferably rectangular in shape having a substantially planar or flat base member 162 and a plurality of vertical sides 164 on each of the four sides. The tray 150 preferably has essentially the same overall dimensions as the cutting board 100. Each of the compartments 160 preferably has a width 166, which is essentially equal to the width of the cutting board and a length 168, which is a fraction (i.e., 1/1, ½, ⅓, ¼) of the length of the cutting board 100. For example, if the length of each of the compartments 160 is a ¼ of the length of the cutting board 100, the cutting board 100 will include 4 (four) compartments 160.

It can be appreciated that at least one of the substantially planar members 110, 120 has a plurality of non-slip protrusions, which prevents the cutting board 110 from sliding around on a counter top or surface. The non-slip protrusions are preferably located on each of the 4 corners of the cutting board. It can be appreciated that the non-slip protrusions are preferably round or shaped otherwise, such that they do not interfere with the cutting surface 112, 122 of the cutting board 100.

In accordance with an exemplary embodiment, the tray 150 has at least one compartment 160 configured to receive food from at least one of the pair of substantially planar members 110, 120. In accordance with an exemplary embodiment, the tray 150 is preferably configured to include a plurality of food compartments 160. Each of the plurality of compartments 160 preferably has a unit of unit of measurement (or volume) used in cooking to measure liquids and/or bulk foods. For example, in accordance with an exemplary embodiment, the unit of measurement is a cup or a fraction thereof (e.g., ⅛ cup, ¼ cup, ⅓ cup, ½ cup or 1 cup). Alternatively, the unit of measurement is a cup of a multiple thereof (i.e., 1 cup, 1 and ½ cups, 2 cups, etc.). It can be appreciated that in accordance with another exemplary embodiment, the unit of measurement is milliliters (ml).

In accordance with another exemplary embodiment, the tray 150 includes a handle 170. It can be appreciated that the handle 170 is a part of, or attachment to the tray 150, which can be moved by hand such as a knob.

It can be appreciated that in accordance with an exemplary embodiment, each of the substantially planar members 110, 120 are cutting surfaces made of a suitable material or composition for cutting and preparing food. The composition of the cutting board 100 is preferably any material that is conducive to cutting and preparing food on, but most preferably would be wood, plastic (e.g., High-density polyethylene (HDPE), polyethylene high-density (PEHD), Thermoplastic elastomer or rubber (TPR), etc.) or silicone material. It can be appreciated that the material is preferably manufactured of food grade material that is sterilizable and dishwasher safe, and wherein such material preferably meeting FDA and Federal specifications, National Sanitation Foundation specifications, accepted by the U.S. and Canadian departments of Agriculture. In accordance with another exemplary embodiment, the composition of the cutting board 100 can also include antibacterial properties.

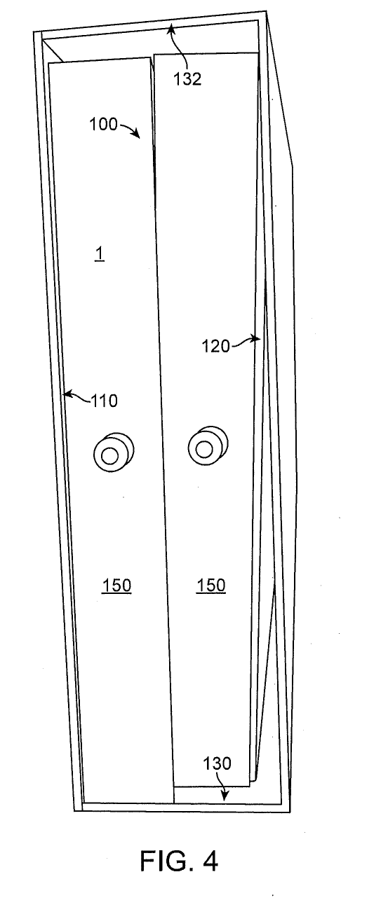

As shown in FIG. 4, the slot or space 140 is preferably configured to receive at least one tray 150. However, it can be appreciated that in accordance with another exemplary embodiment, the slot or space 140 is configured to receive at least two or more trays 150.

In accordance with an exemplary embodiment, at least one of the food compartments 160 is removable. It can be appreciated that in accordance with another exemplary embodiment, each of the food compartments 160 are removable and/or separable from the tray. In accordance with an exemplary embodiment, the at least two support members 110, 120 further include an end member 112. The food compartments are preferably made of wood, and/or plastic, such as high-density polyethylene (HDPE) and/or polyethylene high-density (PEHD).

In accordance with an exemplary embodiment, the cutting board 100 can be used to prepare food by selecting at least one food compartment 160 having a desired volumetric measurement. The cutting board 100 is configured such that upon completion of the slicing, dicing and/or chopping, the food slides off an outer edge of the cutting board 100 and into a selected food compartment 160. It can be appreciated that the process can be repeated until each of the food compartments 160 within the cutting board 100 is filled with sliced, chopped and/or diced food.

It will be understood that the foregoing description is of the preferred embodiments, and is, therefore, merely representative of the article and methods of manufacturing the same. It can be appreciated that variations and modifications of the different embodiments in light of the above teachings will be readily apparent to those skilled in the art. Accordingly, the exemplary embodiments, as well as alternative embodiments, may be made without departing from the spirit and scope of the articles and methods as set forth in the attached claims.

What is claimed is:

1. A cutting board comprising:
a pair of substantially planar members, which are separated by at least two support members and forms a slot or space configured to receive a tray.

2. The cutting board of claim 1, further comprising a tray, which fits between the pair of substantially planar members, the tray having at least one compartment configured to receive food from at least one of the pair of substantially planar members.

3. The cutting board of claim 2, wherein the tray includes a plurality of compartments.

4. The cutting board of claim 3, wherein each of the plurality of compartments have a unit of unit of measurement for volume, used in cooking to measure liquids and/or bulk foods.

5. The cutting board of claim 4, wherein the unit of measurement is a cup or a fraction thereof (e.g., ⅛ cup, ¼ cup, ⅓ cup, ½ cup or 1 cup).

6. The cutting board of claim 4, wherein the unit of measurement is a cup of a multiple thereof (i.e., 1 cup, 1 and ½ cups, 2 cups, etc.)

7. The cutting board of claim 4, wherein each of the plurality of compartments have a unit of measurement of volume of one cup (i.e., one US cup).

8. The cutting board of claim 4, wherein the unit of measurement is milliliters

9. The cutting board of claim 1, wherein the tray includes a handle.

10. The cutting board of claim 1, wherein each of the substantially planar members are cutting surfaces.

11. The cutting board of claim 1, wherein the composition of the cutting board is any material that is conducive to cutting and preparing food on, but most preferably would be a wood, a plastic (e.g., HDPE, TPR, etc.) or a silicone material.

12. The cutting board of claim 11, wherein the material is preferably manufactured of food grade material that is sterilizable and dishwasher safe, and wherein such material preferably meeting FDA and Federal specifications, National Sanitation Foundation specifications, accepted by the U.S. and Canadian departments of Agriculture.

13. The cutting board of claim 12, wherein the composition of the cutting board includes antibacterial properties.

14. The cutting board of claim 1, wherein the slot or space is configured to receive at least one tray.

15. The cutting board of claim 1, wherein the slot or space is configured to receive at least two or more trays.

16. The cutting board of claim 3, wherein at least one of the compartments is removable.

17. The cutting board of claim 3, wherein each of the compartments are removable and/or separable from the tray.

18. The cutting board of claim 2, wherein the tray is a substantially planar member having a pair of vertical edges.

19. The cutting board of claim 1, wherein the at least two support members comprise a pair of side members and an end member.

20. The cutting board of claim 1, further comprising a plurality of non-slip protrusions on a surface of at least one of pair of substantially planar members.
